(19) United States
(12) Patent Application Publication
(10) Pub. No.: US 2009/0308490 A1
(43) Pub. Date: Dec. 17, 2009

(54) PARTICULATE SUBSTANCE COLLECTOR

(76) Inventors: John Bert Jones, Vista, CA (US); Jianzhong Zhang, Brea, CA (US)

Correspondence Address: Robert Yeh, 3764 Herbert St, San Diego, CA, 92103, US

(21) Appl. No.: 12/482,414

(22) Filed: Jun. 10, 2009

Related U.S. Application Data
(60) Provisional application No. 61/061,466, filed on Jun. 13, 2008.

(51) Int. Cl. G01N 1/04

(52) U.S. Cl. 141/98

(57) ABSTRACT

The particulate substance collector described herein comprises a conductive material completely or partially encased in one or more types of non-conductive material(s). The collector can be mounted on a particulate substance collection system, which provides the collector with electrostatic charge. The charged collector is used to attract a measurable amount of particulate substances to the collector. The present invention broadens the range of substances that can be collected to include both conductive and non-conductive particulate materials. Previously, with collectors composed solely of a single material, conductive materials could not be collected. The present invention also broadens the type of receptacle that the particulate substance can be held in, to include both conductive and non-conductive receptacles. The present invention further provides the benefit of minimizing electric shock to the operator who inadvertently contacts the collector during operation.

### CROSS REFERENCE TO RELATED APPLICATION

This application claims priority from and incorporates by reference U.S. Provisional Patent Application No. 61/061,466, titled “Particulate Substance Collector,” filed on Jun. 13, 2008.

### BACKGROUND

1. Field of the Invention

This invention relates to a particulate substance collector. More specifically, a collector for collecting particulate or powdered substances when mounted on an electrostatic charge generating voltage source.

2. Background of Invention

Many fine chemicals and biological compounds are most effectively stored in powdered form. Solid powders or particulate substances, either amorphous or crystalline, are usually more resistant to degradation than the same compounds in solution or liquid form. Many industries, including the pharmaceutical and chemical industries, require frequent and accurate handling of small quantities of particulate substances in the sub-gram to the tens of microgram regime.

Whereas numerous liquid handling devices, such as variants on micropipettes, have been developed for handling small volumes of liquids, comparatively few solid handling systems for small quantities are available. These powder handling systems include those that use mechanical means such as Archimedes screw type devices, pressure differential means such as vacuum or blower devices, and liquefaction means such as vibrators.

A type of powder handling system that is particularly suited for the handling of small quantities of particulate substances utilizes electrostatic forces. One such electrostatic system for collecting particulate substances was previous described. [U.S. Pat. No. 6,948,537] In this system, a voltage generator produces an electrostatic field at the collector. The charged collector, which is made out of a single material, is moved into proximity of the particulate substance which is contained in an electrically insulated receptacle. As the distance between the collector and particulate substance decreases, attractive electrostatic force between collector and particulate substance increases. When a sufficient level of attractive force is reached, portions of the particulate substance move from the insulated receptacle to the collector, where the electrostatic attraction holds the collected particulate substance in place. The system then can measure out desired quantities and deposit the particulate substance via a variety of means.

### Prior Art

It is known from U.S. Pat. No. 6,948,537, titled “Systems and Methods for Collecting a Particulate Substance,” that particulate and powdered substances can be attracted to and collected using collectors that are electrostatically charged with a voltage source. The collectors are typically composed of a metallic material. The metallic collector is conductive on its surface, and is subject to electrical discharge when in proximity with conductive substances or surfaces. The metallic collector is therefore not suitable for the collection of conductive particulate substances such as powdered metal or reduction-oxidation sensitive inorganic complexes. The metallic collector is sensitive to atmospheric moisture affects and moisture in the particulate substances. The metallic collector cannot collect substances from a conductive receptacle because electrical discharge occurs when the metallic collector is in proximity to the conductive receptacle. Electrical discharge from the metallic collector to the skin of a person operating the collector can cause injury.

### SUMMARY

A critical component of the electrostatic particulate substance collection system is the collector, which comes in physical contact with the particulate substance during operation.

The particulate substance collector described herein comprises a conductive material completely or partially encased in one or more types of non-conductive material(s). The collector can be mounted on a particulate substance collection system, which generates electrostatic charge at the said collector. The charged collector is brought into proximity to the particulate substance and electrostatic forces attract a measurable amount of the particulate substance to the collector.

The present invention broadens the range of substances that can be collected to include both conductive and non-conductive particulate materials, including magnetic metals, non-magnetic metals, inorganic salts, ionic materials, organic compounds, and lyophilized biological compounds. The electrically insulated surface(s) of the present collector enables collection of both conductive and non-conductive particulate substances. Previously, with collectors composed solely of a single material, conductive particulate materials such as powders of inorganic ions or metallic substances could not be collected due to electrical discharge from the collector into the substance and consequent decomposition of the substance.

The present invention also broadens the type of receptacle that the particulate substance can be held in, to include both conductive and non-conductive receptacles. Previously, with collectors composed solely of a single material, electrical discharge occurred through conductive receptacles, such as metal beakers, and rendered the collector unable to retain electrostatic charge.

The present invention further provides the benefit of minimizing electric shock to the operator who inadvertently contacts the collector during operation.

Other features and advantages of the present invention will become more readily apparent to those of ordinary skill in the art after reviewing the following detailed description.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1A is a block diagram illustrating an example of collector according to an embodiment of the present invention;

FIG. 1B is a block diagram illustrating an example of collector according to an embodiment of the present invention;

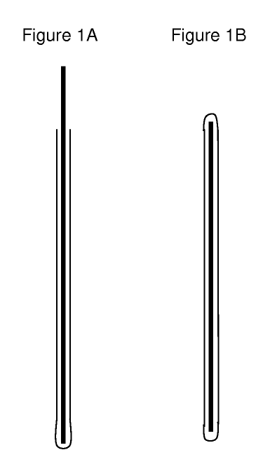

### DETAILED DESCRIPTION

Particulate substance can be any particulate substance capable of submitting to the electrostatic charge carried on the collector. In general, particulate substance has low moisture level, and is a loosely packed powdered or granular substance, comprised of particulates capable of attraction to the electrostatically charged collector.

In one embodiment, a collector contains at its core a conductive material such as a piece of stainless steel, copper or other metallic wire. The core is completely encased in a layer of non-conductive material such as glass, epoxy, polypropylene, polyxylene, polyethylene, perfluorinated polymers, rubber, and polyvinylchloride. The totally encased collector is sealed in such a way as to eliminate any electrical continuity between the conductive material inside the encapsulation and earth ground. To generate electrostatic force on the totally encased collector, a voltage source is brought into close proximity of the collector.

In an alternative embodiment, a collector contains at its core a conductive material such as a piece of stainless steel, copper or other metallic wire. The core is partially encased in a layer of non-conductive material such as glass, epoxy, polypropylene, polyethylene, perfluorinated polymers, rubber, polyvinylchloride. The partially encased collector will be sealed against continuity to earth ground on its surface except for an exposed portion. To generate the attractive force on the partially encased collector, a voltage source is placed in direct contact with the unclad portion of the collector. With the partially encased collector embodiment, the particulate substance contacts the encased portion of the collector.

The shape and size of the collector is dependent on a number of factors including but not limited to specific particulate substance measurement quantity, receptacle size and shape, nature of the particulate substance such as cohesive and adhesive properties, particle density, particle size, shape, charge, atmospheric humidity, water content.

In one embodiment, the collector is a straight cylindrical wire piece as shown in the drawings. The collector can be straight or bent, a loop of any shape, a loop of any shape attached to a straight piece, or a combination of multiple straight pieces, multiple loops, or one or more of the above. The diameter of the wire can be varied. The collector can be flat in shape, such as in the shape of a spatula tip. The collector can be conical, sharp at the end, blunt at the end, or have a combination of geoemetrical features. The surface of the collector can be smooth, bumpy, regular, irregular, or a combination of textures at different parts. Regardless of the shape, the collector contains a conductive material that is fully or partially encased in one or more non-conductive materials.

The thickness, shape, texture, and type of the encasing material is dependent on a large number of factors including but not limited to overall collector size, strength of electrostatic charge required, specific particulate substance measurement quantity, nature of the particulate substance such as cohesive and adhesive properties, density, particle size, shape, charge, atmospheric humidity, water content.

For optimal collection of some particulate substances, more than one encasing layer material is needed to provide appropriate levels of electrical insulation and surface interaction. One embodiment of a multiple layer encased collector consists of an outer layer of perfluorinated polymer encasing an intermediate layer of glass encasing a metallic core. The perfluorinated polymer layer attracts less particulate residue when the electrostatic charge source is switched off, and therefore minimizes sample loss and improves measurement accuracy. The glass layer provides electrical insulation and a stiff structural backbone.

What is claimed is:

1. In particulate substances collecting systems wherein a collector is electrostatically charged, the improvement comprising:
an insulating sheath for the electrostatically charged collector providing means for using electrically conductive receptacles for holding the particulate substances and means for collecting electrically conducting or sensitive particulate substances.

2. The collector of claim 1, wherein the conductive core is fully encased by insulating sheath and the particulate substances are collected on the insulating sheath portion of the collector.

3. The collector of claim 1, wherein the collector is mated to an electrostatics charge source via the insulating sheath portion.

4. The collector of claim 1, wherein the conductive core is partially encased by insulating sheath and the particulate substances are collected on the insulating sheath portion of the collector.

5. The collector of claim 1, wherein the collector is mated with an electrostatics charge source via the exposed conductive core portion.

6. The collector of claim 1, wherein thickness of the insulating sheath is sufficient to shield the particulate substance from electrical discharge.

7. The collector of claim 1, wherein thickness of the insulating sheath is sufficient to shield the collector from electrical discharge to ground via contact with conductive surfaces.

8. The collector of claim 1, wherein the conductive core comprises metallic material or a non-metallic electrically conductive material.

9. The collector of claim 1, wherein the conductive core comprises composite of electrically conductive materials.

10. The collector of claim 1, wherein the insulating sheath comprises plastics material, fluorinated polymers, glass, epoxy, or other non-conducting materials.

11. The collector of claim 1, wherein the insulating sheath comprises a composite of electrically non-conducting materials.

12. The collector of claim 1, wherein the insulating sheath and conducting core are separated from each other by a space occupied by vacuum, air, gas, liquid, or glue.

13. The collector of claim 1, wherein the collector is in the shape of a rod or rods, a sphere or spheres, a cone or cones, a loop or loops, a scoop or scoops, or other shapes with concave or convex surfaces, or a combination of different shapes, to aid the pickup and release of particulate substances.

14. The collector of claim 1, wherein the collector is textured on the surface to aid the pickup and release of particulate substances.

15. A particulate substances collector for the collection of particulate substances when electrostatically charged, the collector comprising an electrically conductive core and an insulating sheath.

16. The collector of claim 15, wherein the conductive core is fully encased by insulating sheath and the particulate substances are collected on the insulating sheath portion of the collector.

17. The collector of claim 15, wherein the collector is mated to an electrostatics charge source via the insulating sheath portion.

18. The collector of claim 15, wherein the conductive core is partially encased by insulating sheath and the particulate substances are collected on the insulating sheath portion of the collector.

19. The collector of claim 15, wherein the collector is mated with an electrostatics charge source via the exposed conductive core portion.

20. The collector of claim 15, wherein thickness of the insulating sheath is sufficient to shield the particulate substance from electrical discharge.

21. The collector of claim 15, wherein thickness of the insulating sheath is sufficient to shield the collector from electrical discharge to ground via contact with conductive surfaces.

22. The collector of claim 15, wherein the conductive core comprises metallic material or a non-metallic electrically conductive material.

23. The collector of claim 15, wherein the conductive core comprises composite of electrically conductive materials.

24. The collector of claim 15, wherein the insulating sheath comprises plastics material, fluorinated polymers, glass, epoxy, or other non-conducting materials.

25. The collector of claim 15, wherein the insulating sheath comprises a composite of electrically non-conducting materials.

26. The collector of claim 15, wherein the insulating sheath and conducting core are separated from each other by a space occupied by vacuum, air, gas, liquid, or glue.

27. The collector of claim 15, wherein the collector is in the shape of a rod or rods, a sphere or spheres, a cone or cones, a loop or loops, a scoop or scoops, or other shapes with concave or convex surfaces, or a combination of different shapes, to aid the pickup and release of particulate substances.

28. The collector of claim 15, wherein the collector is textured on the surface to aid the pickup and release of particulate substances.

What is claimed is:

1. In particulate substances collecting systems wherein a collector is electrostatically charged, the improvement comprising:
an insulating sheath for the electrostatically charged collector providing means for using electrically conductive receptacles for holding the particulate substances and means for collecting electrically conducting or sensitive particulate substances.

2. The collector of claim 1, wherein the conductive core is fully encased by insulating sheath and the particulate substances are collected on the insulating sheath portion of the collector.

3. The collector of claim 1, wherein the collector is mated to an electrostatics charge source via the insulating sheath portion.

4. The collector of claim 1, wherein the conductive core is partially encased by insulating sheath and the particulate substances are collected on the insulating sheath portion of the collector.

5. The collector of claim 1, wherein the collector is mated with an electrostatics charge source via the exposed conductive core portion.

6. The collector of claim 1, wherein thickness of the insulating sheath is sufficient to shield the particulate substance from electrical discharge.

7. The collector of claim 1, wherein thickness of the insulating sheath is sufficient to shield the collector from electrical discharge to ground via contact with conductive surfaces.

8. The collector of claim 1, wherein the conductive core comprises metallic material or a non-metallic electrically conductive material.

9. The collector of claim 1, wherein the conductive core comprises composite of electrically conductive materials.

10. The collector of claim 1, wherein the insulating sheath comprises plastics material, fluorinated polymers, glass, epoxy, or other non-conducting materials.

11. The collector of claim 1, wherein the insulating sheath comprises a composite of electrically non-conducting materials.

12. The collector of claim 1, wherein the insulating sheath and conducting core are separated from each other by a space occupied by vacuum, air, gas, liquid, or glue.

13. The collector of claim 1, wherein the collector is in the shape of a rod or rods, a sphere or spheres, a cone or cones, a loop or loops, a scoop or scoops, or other shapes with concave or convex surfaces, or a combination of different shapes, to aid the pickup and release of particulate substances.

14. The collector of claim 1, wherein the collector is textured on the surface to aid the pickup and release of particulate substances.

15. A particulate substances collector for the collection of particulate substances when electrostatically charged, the collector comprising an electrically conductive core and an insulating sheath.

16. The collector of claim 15, wherein the conductive core is fully encased by insulating sheath and the particulate substances are collected on the insulating sheath portion of the collector.

17. The collector of claim 15, wherein the collector is mated to an electrostatics charge source via the insulating sheath portion.

18. The collector of claim 15, wherein the conductive core is partially encased by insulating sheath and the particulate substances are collected on the insulating sheath portion of the collector.

19. The collector of claim 15, wherein the collector is mated with an electrostatics charge source via the exposed conductive core portion.

20. The collector of claim 15, wherein thickness of the insulating sheath is sufficient to shield the particulate substance from electrical discharge.

21. The collector of claim 15, wherein thickness of the insulating sheath is sufficient to shield the collector from electrical discharge to ground via contact with conductive surfaces.

22. The collector of claim 15, wherein the conductive core comprises metallic material or a non-metallic electrically conductive material.

23. The collector of claim 15, wherein the conductive core comprises composite of electrically conductive materials.

24. The collector of claim 15, wherein the insulating sheath comprises plastics material, fluorinated polymers, glass, epoxy, or other non-conducting materials.

25. The collector of claim 15, wherein the insulating sheath comprises a composite of electrically non-conducting materials.

26. The collector of claim 15, wherein the insulating sheath and conducting core are separated from each other by a space occupied by vacuum, air, gas, liquid, or glue.

27. The collector of claim 15, wherein the collector is in the shape of a rod or rods, a sphere or spheres, a cone or cones, a loop or loops, a scoop or scoops, or other shapes with concave or convex surfaces, or a combination of different shapes, to aid the pickup and release of particulate substances.

28. The collector of claim 15, wherein the collector is textured on the surface to aid the pickup and release of particulate substances.
